(19) United States
(12) Patent Application Publication
(10) Pub. No.: US 2004/0249793 A1
(43) Pub. Date: Dec. 9, 2004

(54) Efficient document storage and retrieval for content servers

(76) Inventor: Hans-Joachim Both, Walldorf (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/454,389

(22) Filed: Jun. 3, 2003

(51) Int. Cl. G06F 7/00

(52) U.S. Cl. 707/3

(57) ABSTRACT

A process for storing a document in a document repository using a content server begins with receiving a client request to store a document. The process then generates a query object to validate the client request. Next, the process generates a document object to initiate a transaction in the document repository using data in the client request. The process also generates a data retrieval object to read data from a client, wherein the data comprises a component of the document. Finally, the process stores the component in the document repository.

### BACKGROUND

This invention relates to document storage and retrieval.

Web based storage and retrieval of documents in a database or a file system repository can be a cumbersome and inefficient process when large documents are being processed. In web-based systems, content servers are often used to provide an interface to a database or file system repository. During document storage transactions, these content servers will read an entire document from a network user before processing the document for storage. The entire document is therefore present in a main memory of a computer system that is running the content server program. The entire document will remain in the computer system main memory until all of the associated storage steps are completed. If the content server uses objects to perform each of the different storage processing steps, each object will receive the entire document before it will execute its designated function. Once all of the objects have processed the entire document, the document is finally written into a document repository. Similarly, when a document is retrieved from the document repository, the entire document is stored in the main memory of the computer system running the content server program until all of the steps associated with retrieval are completed.

For large documents (e.g., example computer aided drawings (CAD), huge engineering models, video files, image files, portable document format (PDF) files, and multi-component documents), consuming large amounts of the computer system main memory to store the entire document during storage or retrieval processing results in poor memory behavior and uses a large portion of the computer's resources. This reduces computer system performance. Also, depending on the amount of main memory in the computer system available, this sets an upper limit to the size of documents the content server can process. In addition, when multiple users are accessing the content server simultaneously, the overall system performance will be poor for all users.

### SUMMARY

The invention provides a process for storing and retrieving documents in a document repository using a content server while conserving a main memory of the content server. According to one implementation of the invention, a process for storing a document in a document repository using a content server begins with receiving a client request to store a document. The process then generates a query object to validate the client request. Next, the process generates a document object to initiate a transaction in the document repository using data in the client request. The process also generates a data retrieval object to read data from a client, wherein the data comprises a component of the document. Finally, the process stores the component in the document repository.

According to another implementation, a process for storing a multi-component document in a document repository using a content server begins by receiving a client request to store a document that includes at least two components. The process generates a query object to validate the client request. Then the process generates a document object to initiate a transaction in the document repository using data in the client request and to read at least one boundary string from a client, wherein the boundary string is used to separate the components. Next the process generates a data retrieval object and reads data from the client with the data retrieval object, wherein the data comprises the at least two components. Finally, the process stores the components in the document repository.

According to yet another implementation of the invention, a process for retrieving a document from a document repository using a content server begins by receiving a client request to retrieve a document. The process then generates a query object and validates the client request with the query object. Next, the process generates a document object to initiate a transaction in the document repository using data in the client request. The process then generates a data retrieval object to read data from the document repository, wherein the data comprises a component of the document, and the component is then sent to the client.

In accordance with another implementation of the invention, a process for retrieving a multi-component document from a document repository using a content server begins by receiving a client request to retrieve a document that includes at least two components. The process generates a query object to validate the client request. Next, the process generates a document object to initiate a transaction in the document repository using data in the client request and to send at least one boundary string to a client, wherein the boundary string is used to separate the components. Then the process generates a data retrieval object to read data from the document repository, wherein the data comprises the at least two components, and finally the process sends the components to the client.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exemplary content server.

FIG. 2 is a process executed by the server state object during a document storage request.

FIG. 3 is a process executed by the query object during a document storage request.

FIG. 4 is a process executed by the document object during a document storage request.

FIG. 5 is a process executed by the component object during a document storage request.

FIG. 6 is a process executed by the compressor object and the repository object during a document storage request.

FIG. 7 is a process executed by the component object during a document storage request.

FIG. 8 is a process executed by the document object during a document storage request.

FIG. 9 is a process executed by the query object during a document storage request.

FIG. 10 is a process executed by the server state object during a document storage request.

FIG. 11 is a process executed by the server state object during a document retrieval request.

FIG. 12 is a process executed by the query object during a document retrieval request.

FIG. 13 is a process executed by the document object during a document retrieval request.

FIG. 14 is a process executed by the component object during a document retrieval request.

FIG. 15 is a process executed by the decompressor object and the repository object during a document retrieval request.

FIG. 16 is a process executed by the component object during a document retrieval request.

FIG. 17 is a process executed by the document object during a document retrieval request.

FIG. 18 is a process executed by the query object during a document retrieval request.

FIG. 19 is a process executed by the server state object during a document retrieval request.

### DETAILED DESCRIPTION

The invention provides an efficient process for users of a network, herein referred to as clients, to access a network repository. The repository is a physical storage device that clients access to perform transactions such as storing documents, retrieving documents, deleting documents, modifying documents, or searching documents. There are two primary server programs used to execute the transactions between the clients and the repository, a web server program and a content server program.

On the client side, the web server program generates client requests that contain the transactions the clients want to perform. The web server passes the client requests over a network connection to the repository. Web server programs available to generate client requests include, but are not limited to, the Apache Web Server, the Microsoft® Internet Information Server, or SAP® ICM.

On the repository side, the content server program is the interface that receives the client requests from the web server. The content server then implements software and/or hardware methods to process and execute the requested transactions with the repository. There are many different tasks that are completed to process and execute a client request, and the content server uses one or more objects to perform each of these different tasks. In object-oriented programming, objects are units of code that are self-contained entities formed of both data and procedures to manipulate the data. An object runs in the computer. The procedures executed by the objects are routines, subroutines, and functions that perform specific tasks. The procedures can also be an ordered set of tasks for performing some action.

When a document is stored or retrieved using conventional content servers, the entire document will pass through each of the objects used by the content server. For large documents, this process consumes a large portion of the main memory of a computer system that is running the content server program. This results in slower and less efficient processing by the content server.

In some network environments, a document can become very large because several components can be used collectively to form a single document. A document can include separate components for text, graphics, sound, hypertext markup language (HTML) coding, spreadsheets, and other data. Components, also known as file objects, are data items that can be stored and retrieved, including but not limited to, text files (e.g., .doc, .txt, and .wpd files), image files (e.g., .bmp, .gif, and jpg files), sound files (e.g., .mp3, .wav, and .wmv files), video files (e.g., .mpg and .avi files), and HTML files. For example, a Web home page for a business can be a single document that includes separate components or file objects that contain the text of the home page in several languages, graphics associated with the home page, sound files to be played when the home page is viewed, and the HTML coding necessary to render these components in a web browser. These components should be grouped together in a file system as they are generally stored and retrieved together, and as they all generally share a common document name. The document name is an abstract name that refers collectively to all of the components that form the document. The components each have their own file names as well. The group of components are generally stored and retrieved using the abstract document name.

The document can include a document header that contains information about the overall document, such as whether the document has one or more components, a total length of the document, an arbitrary boundary string used to separate components in the document, and Multi-Purpose Internet Mail Extension (MIME) information about the document. The MIME information provides information about the type of content the document contains. The MIME information in the header allows the system opening the document to select an appropriate software application to open and process the type of data the header indicates. If the document contains only one component, the MIME information can be for that one component. If the document contains more than one component, then the MIME information will indicate that the document is a multipart/form-data document and the specific MIME information for each component is included in its own separate component header. Other information about the document can be included in the header as well.

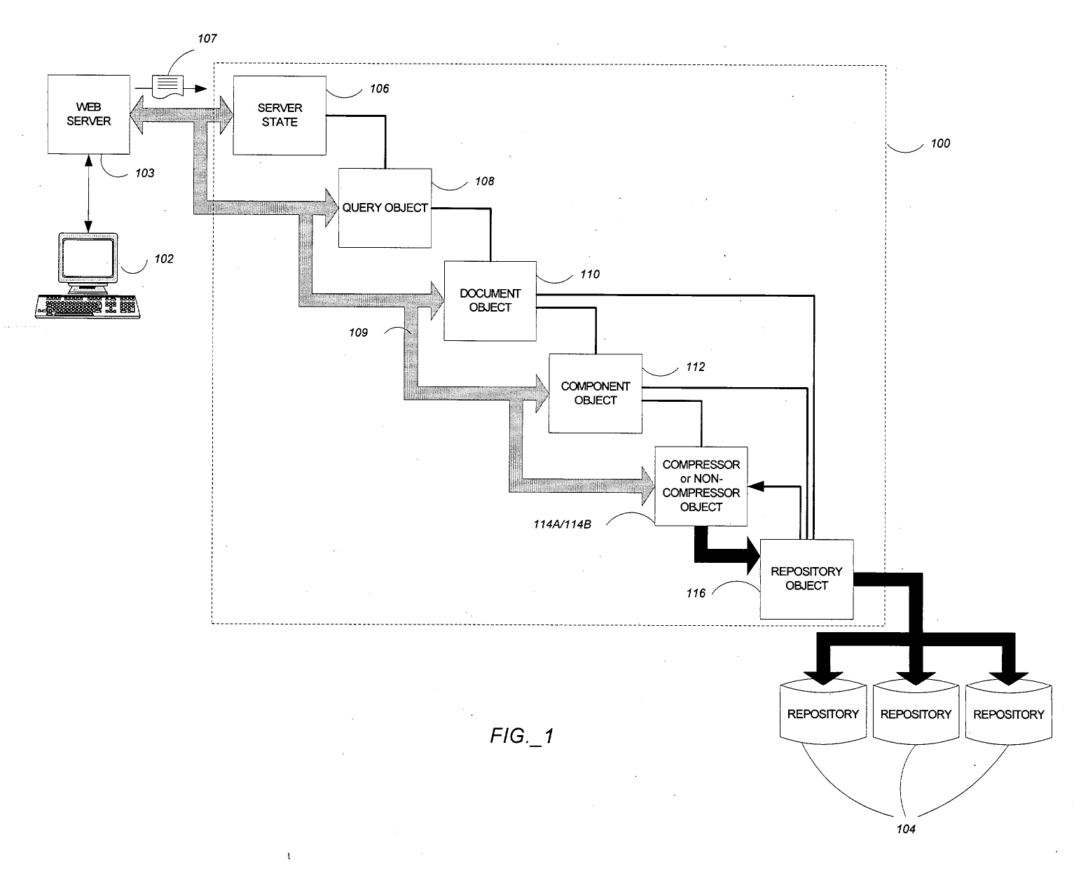

In FIG. 1, an exemplary content server 100 with functionality to store, retrieve, modify, or perform other actions on documents that are formed from one or more components is shown. The content server 100 communicates with one or more clients 102, generally through a web server 103. The content server 100 communicates with one or more repositories 104 that can store the documents. The repositories 104 implement database management systems or file systems to store documents on a physical storage device. An example of a file system that can be used to store and retrieve documents on a physical storage device without the use of a database system is disclosed in a U.S. patent application entitled “File System Storage,” filed on May 23, 2003 and which is incorporated by reference herein in its entirety.

An object of the content server 100 that first communicates with the client 102 is a server state object 106. Again, the web server 103 generally functions as the interface between the content server 100 and the client 102. The content server 100 generates the server state object 106 when the web server 103 is first initialized. The server state object 106 is always active and awaits client requests to arrive from the web server 103.

Client requests generally arrive from the client 102 through the web server 103 in a form of a large data structure called a request record 107. The request record 107 contains data relating to the document that is being stored or retrieved. If the network is implemented using the HyperText Transfer Protocol (HTTP), and HTTP requests are used for executing client commands, the data in the request record 107 can include a Universal Resource Locator (URL) that the client has accessed. A URL is a string that uses a standard syntax to identify an access protocol, location, and identifier for a file or other resource. For Web pages, the typical URL identifies the HTTP protocol, an Internet server location, and a file path and name. But URLs can be used in applications other than Web browsers and can reference many types of resources besides files containing HTML source. In this context, the URL generally contains information such as the command that the client 102 is requesting be executed, the name of the document, the component name if the document contains only one component, and the name of the repository 104 that the document should be stored in or that the document is currently located within. The URL can contain other information as well, including a URL signature if provided. The request record 107 also includes a document header for the document being stored or retrieved. The web server 103 that delivers the request record 107 generally parses the document header prior to sending the request record 107 to the server state object 106.

The request record 107 also includes a socket identifier that is used to identify an established socket connection over which the content server 100 can communicate data to and from the client 102. The web server 103 establishes this socket connection at the time the client request is received by the server state object 106, and the socket connection is generally a software object that connects the content server 100 to a network protocol. For example, the content server can send and receive Transmission Control Protocol/Internet Protocol (TCP/IP) messages by opening a socket and reading and writing data to and from the socket. A stream interface object 109, generated within the content server 100, is used to handle socket related operations.

The server state object 106 processes the request record 107 to generate a request object and a response object. The request and response objects are representations of the request record 107 that can be understood by the content server 100. The request and response objects provide a common interface between the content server 100 and all of the different web servers that may attempt to communicate with the content server 100. The request object generally contains the information that was in the request record 107, including the URL accessed by the client 102 and the document header. The request object provides a stream interface input 109 for the objects of the content server 100 from which the objects can read data from the client, and the response object provides a stream interface output 109 for the objects of the content server 100 into which the objects can write data to the client. The server state object 106 also generates a request state object into which the request object and the response object are packaged. The request state object acts as an envelope for the request and response objects so they can be passed between objects, and so additional objects can later be packaged with the request and response objects.

Another function of the server state object 106 is to generate and be in communication with a query object 108. The query object 108 operates primarily on the URL that was accessed by the client 102 and is now contained in the request object. The query object 108 parses the URL to break it apart and generate a parameter and value table. The value table lists the parameters included in the URL, and associates each parameter with its corresponding value. For instance, the document name parameter is associated with the document name provided in the URL, the repository parameter is associated with the actual repository name specified by the URL, and the security parameter is associated with the signature provided by the URL.

When the query object 108 parses the URL, it validates most or all of the items that are provided. For the command that is requested by the client 102 in the URL, the query object 108 can determine whether the client 102 has the appropriate access rights or permissions to request that command. For example, if the client 102 requests that a document be deleted, the query object 108 can determine whether the client 102 has the appropriate authorization to allow him or her to request that the document be deleted. The query object 108 also makes certain that the minimum parameters that are required to execute the requested command are present. If security is enabled, the query object 108 can check a security signature in the URL. And the query object 108 can also verify that the requested repository exists and is available.

Once the query object 108 has validated the items in the URL, it can call the appropriate command on the content server 100. These commands include, but are not limited to, commands such as generating a single component document, generating a multi-component document, retrieving a single component document, retrieving a multi-component document, deleting a document, appending a document, updating a document, or searching a document. The query object 108 also generates and is in communication with a document object 110.

The document object 110 oversees the storage and retrieval of the components that form the document. The primary pieces of information required by the document object 110 are the document name and the arbitrary boundary string used to separate components in the document. The document name and boundary string are retrieved from the document header that is passed to the document object 110 by the query object 108 in the request object.

The document object 110 is responsible for initiating a transaction in the repository 104 and informing the repository 104 that a document is going to be stored or retrieved. For a storage process, if the document is formed from multiple components, the document object 110 reads the boundary string out of the stream interface 109 (i.e., the socket) so that the component header is the next item of data available in the stream interface 109. This prevents the boundary string from being read by another object that may confuse the boundary string with the actual component header. In a retrieval process, if there are multiple components in the document, the document object 110 writes the boundary string into the stream interface 109 in between the components as they are sent to the client.

Another task of the document object 110 is to generate and be in communication with a component object 112. The component object 112 operates on only one component and generates and controls other objects to store or access the component in the repository 104. If the document only has one component, the component object 110 obtains information about the component from the document header that is passed to it by the document component 110 or read from the repository 104. If the document contains multiple components, the document header will not have any information about a particular component. In that case, the component object 112 reads the component header from the stream interface 109 or from the repository 104 to obtain information about the component.

The information about the component includes the name of the component, the length of the component, and its MIME information. In a storage process, the component object 112 uses this information to determine whether the component needs to be compressed prior to storage in the repository 104. The component object 112 bases this determination on a set of rules established by the web server and the content server 100 when they are initialized. These rules govern which types of files need to be compressed for each repository. Different repositories may require that different file types be compressed. Based on these rules, the component object 112 looks at the component information provided in the header and decides if a particular component needs to be compressed. Typically, it is the information regarding the file type (MIME) and the requested repository 104 that is used to make this determination.

The component object 112 also stores properties of the components in the repository 104 after the storage processing of all of the components is complete, or it retrieves the component properties during a retrieval process. These properties include the component names, the content types, the compressed lengths, the uncompressed lengths, the compression algorithms used, any protection rights, and any other desired properties, such as time stamps. Many of these component properties are determined during the processing of the components and are therefore unavailable until processing is complete.

The component object 112 is responsible for generating and being in communication with objects used to retrieve the bulk of the data from the client 102. These data retrieval objects can include a compressor object 114A or a non-compressor object 114B. The compressor object 114A reads data out of the stream interface 109 and applies a compression algorithm to compress that data. The non-compressor object 114B also reads data from the stream interface 109, but it does not perform any compression processing to the data that it reads. So the component object 112 generates a compressor object 114A for storing components that need to be stored as compressed data, and the component object 112 generates a non-compressor object 114B for components that need to be stored as uncompressed data.

The compressor object 114A and the non-compressor object 114B read the bulk of the data from the stream interface 109; this data corresponds to the actual components being processed. The previous objects required little or no data from the stream interface 109. Unlike conventional content servers that pass the entire document from one object to the next, in the content server 100, the majority of the data that forms the document is read from the stream interface 109 only near the end of the process by the compressor object 114A or the non-compressor object 114B. Therefore the main memory of the content server 100 is conserved during the majority of the processing, making the process faster and more efficient. There is no need for each object within the content server to read and process the entire contents of the document. Each object only receives the data it needs to perform its function, which greatly reduces the load on the content server 100.

During a document retrieval process, the component object 112 generates and uses objects to retrieve the bulk of the data from the repository 104. In this case, a decompressor object and a non-decompressor object replace the compressor object 114A and the non-compressor object 114B. The decompressor object reads compressed data from the repository 104 and applies a decompression algorithm to decompress the data before writing the data to the stream interface 109. The non-decompressor object reads uncompressed data from the repository and writes it to the stream interface 109 without altering the data.

The query object 108 also generates a repository object 116. The repository object 116 contains information regarding which physical repository 104 is being requested for the document to be stored in or retrieved from. The repository object 116 is responsible for the actual reading from and writing to the physical storage devices that form the repository 104. The URL in the request object provides the name of the particular repository 104 that is needed for a particular client request.

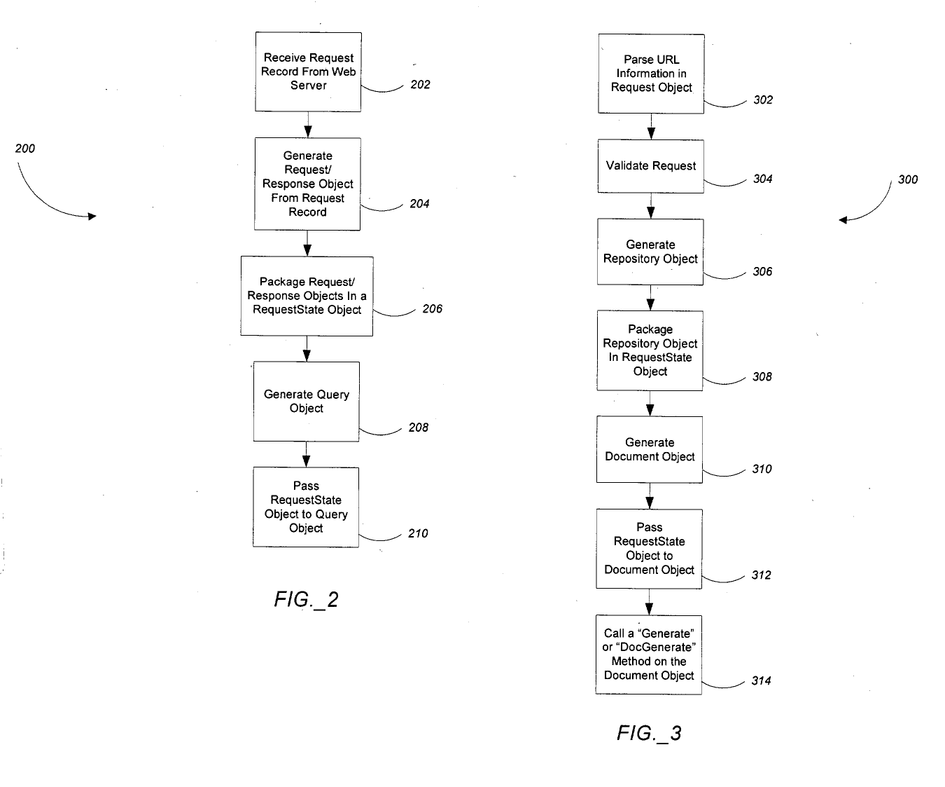

In FIG. 2, the server state object executes a process 200 when the client 102 sends a request to store a document. The server state object initially receives the request from the client to store the document (202). The request is generally packaged in a request record. Next, the server state object takes the information in the request record, which can arrive from any of a number of different web servers, and generates a request object and a response object (204). The request and response objects include information about the request as well as the socket identifier. The server state object then packages the request and response objects in a request state object (206). The request state object is a data structure that can be passed from one object to the next. Because it contains the request and response objects, these objects can now be passed between objects in the content server. Additional data items can be added to the request state object as needed. The server state object then generates a query object (208) and passes the request state object to the query object (210). Because the request state object contains the request object, information such as the socket identifier is included. This information enables the query object, or any other object in the content server that receives the request object in the request state object, to read data out of the stream interface, thereby providing access and the ability to retrieve data from the client. Similarly, the response object enables the objects in the content server to write data to the client over the stream interface.

In FIG. 3, the query object executes a process 300 when it receives a request state object from the server state object during a document storage request. The query object first retrieves the URL from the request object and parses the URL information (302). Recall that this is the URL that was accessed by the client when the document storage request was made. After parsing the URL, the query object validates the client request (304). This includes verifying that the client has authorization to make the request and that all of the required parameters are present. The query object generates a repository object (306) that will be used to interface with the physical repository. The repository object contains the name of the specific repository that is being accessed, and this repository name is located in the URL. The repository object is then packaged into the request state object where it joins the request and response objects (308). This enables the repository object to be shared with all of the objects in the content server. The query object also generates a document object (310) and passes the request state object to the document object (312). Finally, the query object instructs the document object to execute a document storage method (314). If the document being stored only contains one component, the query object calls a “generate” method on the document object. If the document being stored contains multiple components, the query object calls a “docGenerate” method on the document object. This immediately tells the document object whether it will be processing a single component document or a multi-component document.

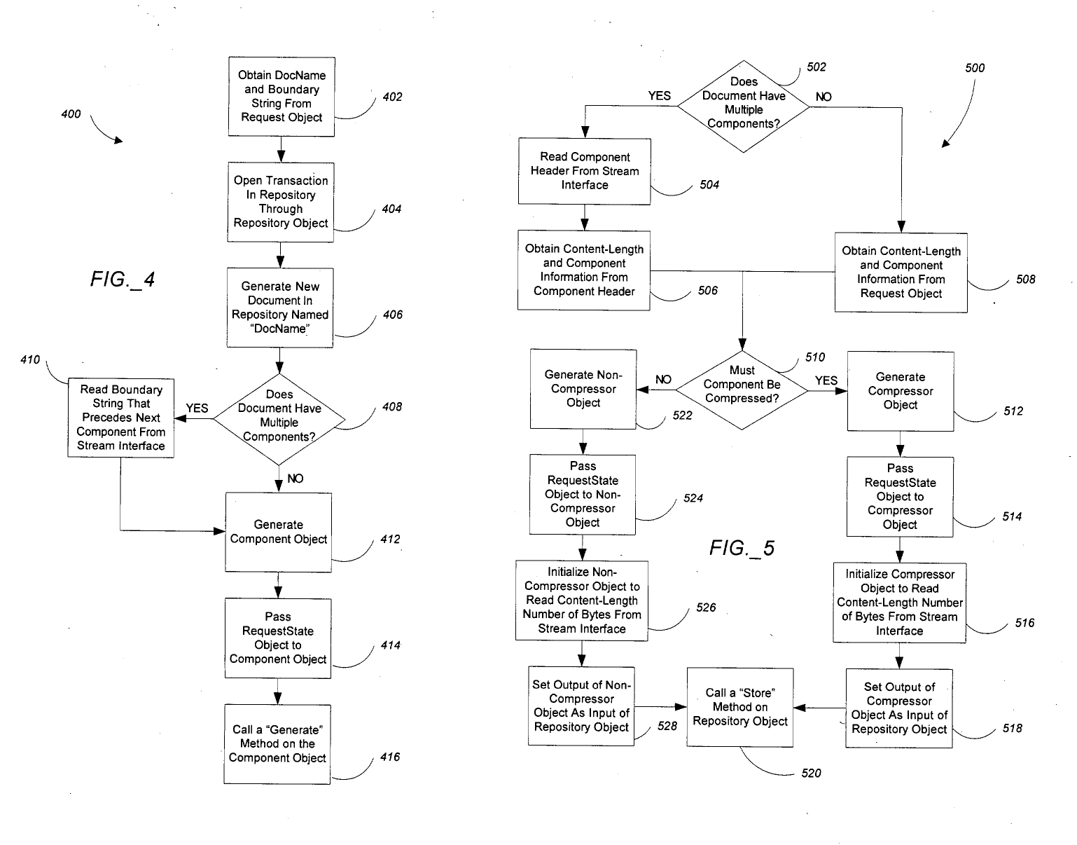

In FIG. 4, the document object executes a process 400 when it receives a request state object from the query object during a document storage request. The document object retrieves the name of the document being stored from the request object in the request state object (402). If the document has multiple components (i.e., if the query object called a “docGenerate” method on the document object), the document object retrieves boundary information from the request object (402). The boundary information generally comprises an arbitrary string of characters that are used to separate the data that forms each component. The document object can locate the boundary strings and find the beginning of each component. The document object also opens a transaction in the repository using the repository object (404), the repository object having been passed to the document object in the request state object. Next, the document object generates a document placeholder in the repository using the retrieved document name (406). This is an open slot in the repository where the components can be stored.

Once the document placeholder has been generated in the repository, the document object starts the process of adding one or more components into the document placeholder. The document object first determines whether the document being stored has a single component or multiple components (408). This information is implicit in the method called by the query object (generate and docGenerate). If the document has multiple components, the document object reads the first boundary string from the stream interface (410). This action adjusts the data coming in from the stream interface so that the next byte of data is the beginning of a component header. If the document has a single component, the next byte of data coming in from the stream interface is the beginning of the component itself. For a single component document, there is no need for a component header because the component information is generally contained in the document header. The document object then generates a component object (412) and passes the request state object to the component object (414). The document object also calls a “generate” method on the component object (416).

In FIG. 5, the component object executes a process 500 when it receives a request state object from the document object during a document storage request. If the document has multiple components (502), the component object reads the component header from the stream interface (504) and obtains information about the next component to be stored, such as the length of the component, the component name, and the MIME information for the component (506). Other component information can also be contained in the component header. If the document has only one component, the component object retrieves the same component information but from the document header included in the request object (508).

Using the component information, the component object determines if the component needs to be compressed (510). If compression is necessary, the component object generates a compressor object to perform the compression of the data (512). The component object then passes the request state object to the compressor object (514) and initializes the compressor object to read a number of bytes from the stream interface that correspond to the length of the component (516). This provides that the entire component is passed through the compressor object. The component object also sets the output of the compressor object as the input of the repository object (518). This sends the compressed object to the repository object. The component object then calls a “store” method on the repository object to cause the repository object to place the compressed component into the repository in the document placeholder that was generated by the document object (520).

If compression of the component is not necessary, the component object generates a non-compressor object (522) to read the component from the stream interface without compressing it. The use of a non-compressor object allows the process executed by the component object to be the same regardless of whether a component is being compressed or not. As with the compressor object, the component object passes the request state object to the non-compressor object (524) and initializes the non-compressor object to read a number of bytes from the stream interface that correspond to the length of the component (526). The component object also sets the output of the non-compressor object as the input of the repository object (528) and, as above, calls a “store” method on the repository object (520).

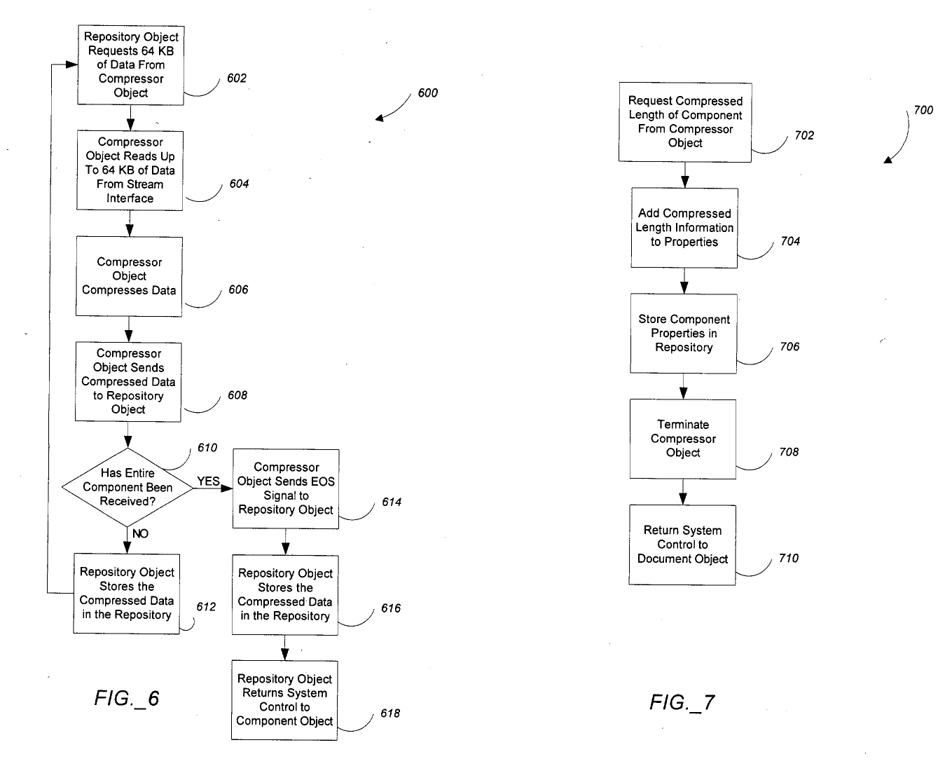

In FIG. 6, the compressor object and the repository object execute a process 600 when the compressor object receives a request state object from the component object during a document storage request. After the component object has called a “store” method on the repository object, the repository object requests a quantity of data from the compressor object (602). In one implementation, the repository object can request 64 KB of data at a time from the compressor object as this is a common buffer size. Next, the compressor object reads the quantity of data from the stream interface (604). This is the first time in the overall document storage process that a large quantity of the main memory of the computer system running the content server is being used because the content server is finally reading the bulk of the document data from the stream interface. Until this point, the reads from the stream interface has been small amounts of data representing document or component headers, which are typically less than 64 KB in size. Therefore, the load on the content server is greatly reduced for the majority of the document processing, resulting in better and more efficient content server performance.

Once the data is read, the compressor object compresses the data (606) and sends the compressed data to the repository object through its output (608). Because the compressor object has been initialized to read a number of bytes from the stream interface that corresponds to the length of the component, it will only read the bytes that form the component. If the entire component has not been read (610), the repository object can store any data it has received in the repository (612) and then request more data from the compressor object (602). Typically, the repository object will receive data from the compressor object until its buffer is full before it outputs the compressed data into the physical repository. So for a repository object using a 64KB buffer, it will continue requesting data from the compressor object until it has received 64KB of data before dumping that data into the physical repository. Once the compressor object has read the entire component (610), the compressor object sends an “end of stream” signal to the repository object (614). The repository object then sends any compressed data it has in its buffer to the physical repository (616) and returns control of the system back to the component object (618).

For components that do not require compression, the process of reading the component from the stream interface and storing the component in the physical repository mirrors the process described in FIG. 6. The primary difference is that the non-compressor object will not compress the data after reading the data from the stream interface. Otherwise, the process is executed in an almost identical way.

In FIG. 7, the component object executes a process 700 when the repository object returns system control to the component object. The component object knows that the component has been compressed and stored, so it can request the compressed length of the component from the compressor object (702). The component object then adds this compressed length information to the properties of the component (704) and stores the component properties in the physical repository with the component itself (706). The process of storing this particular component is now complete, so the component object terminates the compressor object (708) and returns system control to the document object (710).

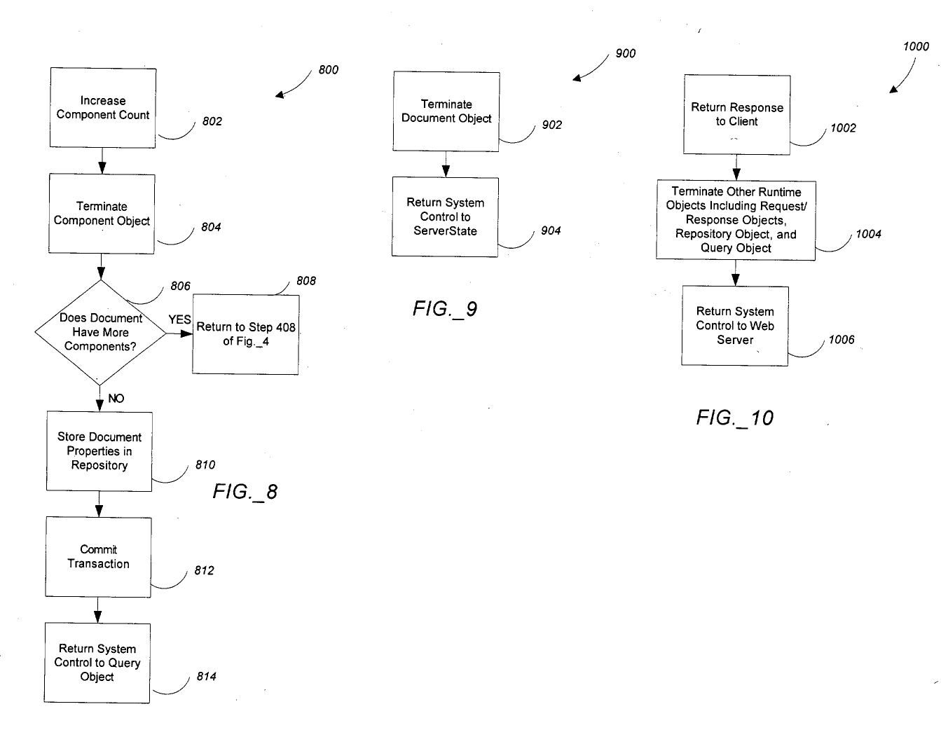

In FIG. 8, the document object executes a process 800 when the component object returns system control to the document object. The document object keeps track of the number of components being stored and increases the component count accordingly (802). The document object then terminates the component object (804) and determines if another component is waiting at the client to be read and stored in the repository (806). If there is another component to be stored, the document object generates a new component object (408 of FIG. 4) and the process of storing a component is executed again (808). If there are no more components to be stored, the document object stores all of the overall document properties in the repository (810) and commits the transaction (812). The process of committing a transaction finalizes the storing process and the physical repository finalizes the saving of the component data. The document object then returns system control to the query object (814).

In FIG. 9, the query object executes a process 900 when the document object returns system control to the query object. The query object simply terminates the document object (902) and returns system control to the server state object (904). In FIG. 10, the server state object executes a process 1000 when it receives system control from the query object. The server state object returns a response to the client that generally tells the client whether or not the request to store the document was completed successfully (1002). The server state object then terminates any remaining run time objects generated during the storage process, including the request object, the response object, the repository object, and the query object (1004). Finally, the process of storing the document is complete and the server state object returns control of the system back to the web server (1006).

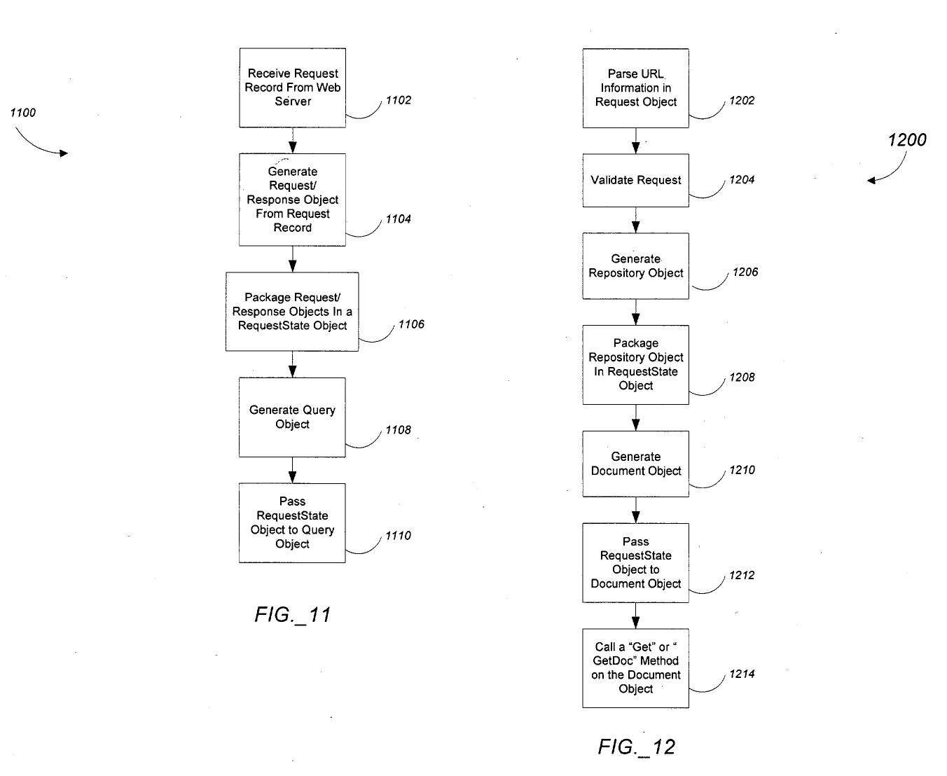

In FIG. 11, the server state object executes a process 1100 when the client sends a request to retrieve a document. The server state object initially receives the request from the client to retrieve the document (1102). As before, the request is generally packaged in a request record. Next, the server state object takes the information in the request record and generates a request object and a response object (1104). The request and response objects include information about the request as well as the socket identifier. The server state object then packages the request and response objects in a request state object (1106). The server state object generates a query object (1108) and passes the request state object to the query object (1110). Because the request state object contains the response object, the socket identifier is included and can be used by the objects in the content server to write data into the stream interface that is then sent to the client.

In FIG. 12, the query object executes a process 1200 when it receives a request state object from the server state object during a document retrieval request. The query object first accesses the URL from the request object and parses the URL information (1202). After parsing the URL, the query object validates the client request (1204). Again, this includes verifying that the client has authorization to make the request and that all of the required parameters are present. The query object generates a repository object (1206) that is used to interface with the physical repository. The repository object is packaged into the request state object with the request and response objects (1208), allowing the repository object to be shared with all of the objects in the content server. The query object generates a document object (1210) as well and passes the request state object to the document object (1212). Finally, the query object instructs the document object to execute a document retrieval method (1214). If the document being retrieved only contains one component, the query object calls a “get” method on the document object. If the document being retrieved contains multiple components, the query object calls a “getDoc” method on the document object. This immediately tells the document object whether it will be processing a single component document or a multi-component document.

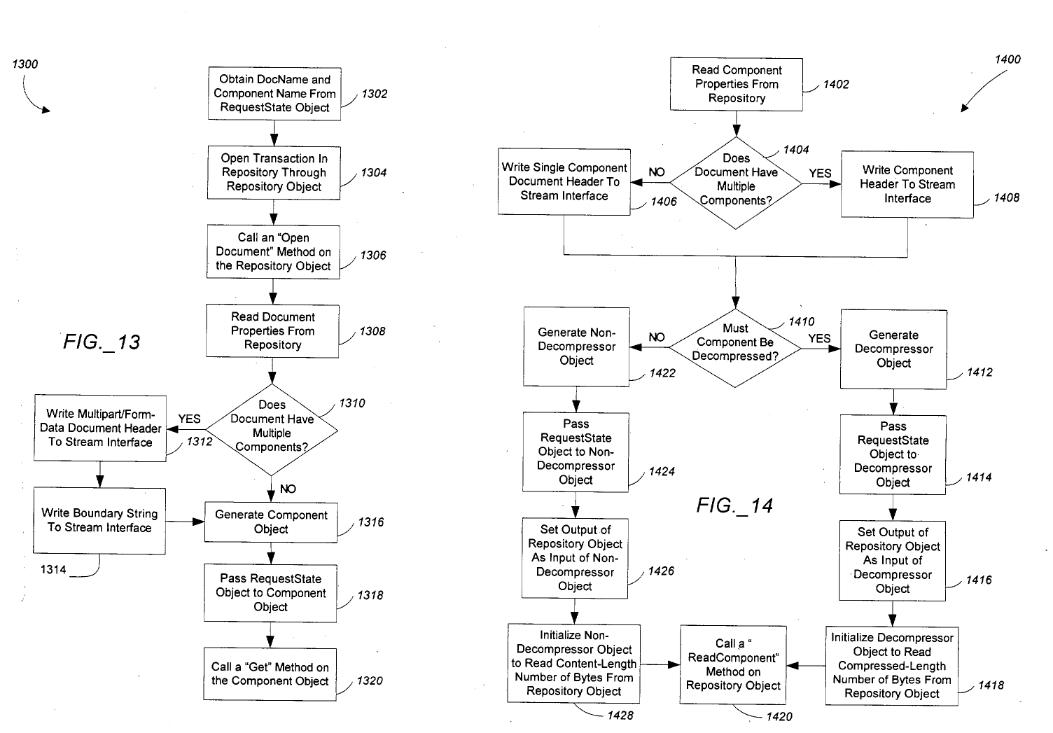

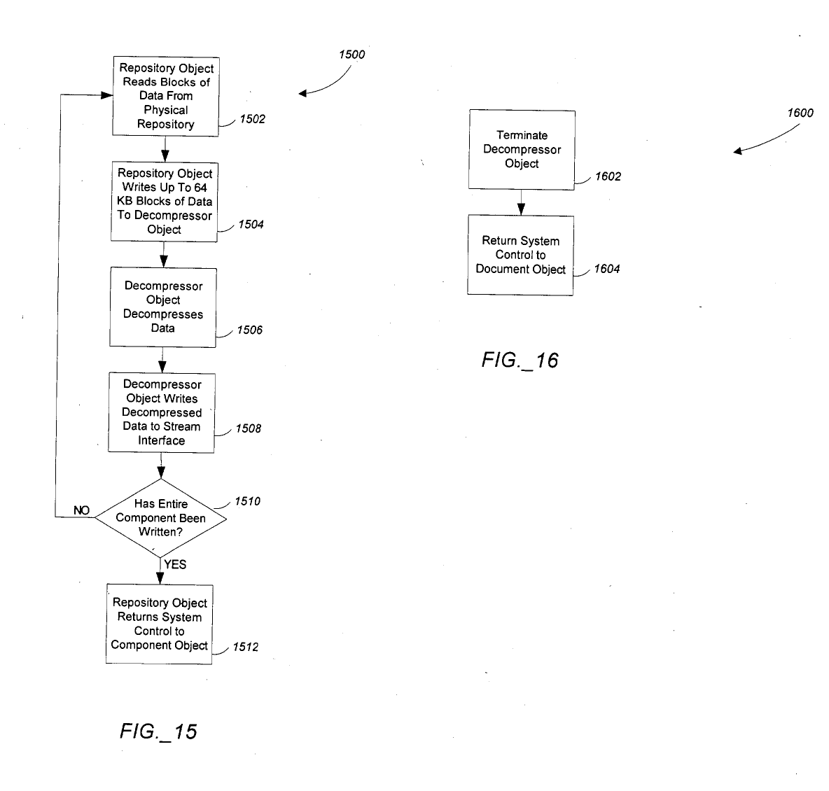

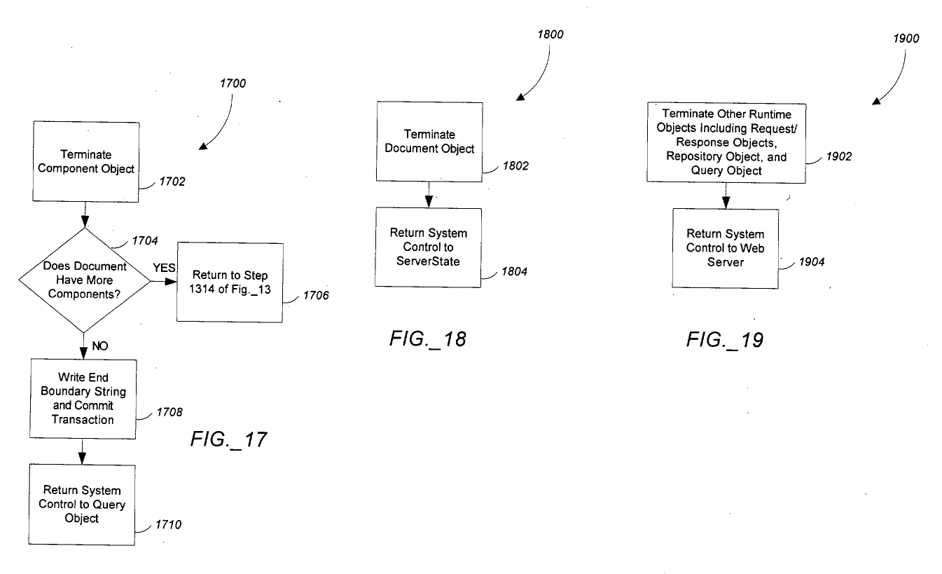

In FIG. 13, the document object executes a process 1300 when it receives a request state object from the query object during a document retrieval request. The document object accesses the name of the document being stored from the request state object (1302). If the document has a single component, the document object can also retrieve the component name from the request state object (1302). The document object opens a transaction in the repository using the repository object that is stored in the request state object (1304). Next, the document object calls an “open document” method on the repository to access the stored document so its components can be retrieved (1306). Once the document is open, the document object can read the document properties out of the repository (1308).

The document object can now start the process of retrieving one or more components from the document in the repository. The document object first determines whether the stored document has a single component or multiple components (1310). This information is implicit in the method called by the query object (get and getDoc). If the document has multiple components, the document object writes a document header into the stream interface that includes a multipart/form-data entry (1312) and specifies the arbitrary string used as a boundary. The document object also writes an actual boundary string into the stream interface (1314) to designate that a new component is following. For a single component document, the component object generates the document header as discussed below. The document object then generates a component object (1316), passes the request state object to the component object (1318), and calls a “get” method on the component object (1320).

In FIG. 14, the component object executes a process 1400 when it receives a request state object from the document object during a document retrieval request. The component object begins by reading the component properties out of the repository (1402). If the document has multiple components (1404), the component object writes a component header into the stream interface (1408) that includes information about the next component to be retrieved, such as the length of the component, the component name, and the MIME information for the component. If the document has only one component, the component object writes a single component document header into the stream interface (1406). This document header is the overall document header and includes information about the single component.

Using the component information that was read, the component object determines if the component being retrieved needs to be decompressed (1410). If decompression is necessary, the component object generates a decompressor object to perform the decompression of the data (1412). The component object then passes the request state object to the decompressor object (1414) and sets the output of the repository object as the input of the decompressor object (1416). The component object then initializes the decompressor object to accept a number of bytes from the repository object that correspond to the compressed length of the component (1418). This provides that the entire compressed component is passed through the decompressor object and decompressed. The component object then calls a “read component” method on the repository object to cause the repository object to read the compressed component from the repository and write the compressed component into the decompressor object (1420).

If decompression of the component is not necessary, the component object generates a non-decompressor object (1422) to read the component from the repository without decompressing it. As with the decompressor object, the component object passes the request state object to the non-decompressor object (1424) and sets the output of the repository object as the input of the non-decompressor object (1426). The component object initializes the non-decompressor object to read a number of bytes from the repository object that correspond to the length of the component (1428). The component object also calls a “read component” method on the repository object (1420).

In FIG. 15, the decompressor object and the repository object execute a process 1500 when the decompressor object receives a request state object from the component object during a document retrieval request. After the component object has called a “read component” method on the repository object, the repository object reads a quantity of data from the physical repository (1502). In one implementation, the repository object can read 64 KB blocks of data at a time from the physical repository as this is a common buffer size. Next, the repository object writes the retrieved data into the input of the decompressor object (1504). This is the first time in the overall document retrieval process that a large quantity of RAM is being used on the content server because the bulk of the document data is being retrieved and written to the stream interface.

Once the data is output by the repository object, the decompressor object receives and decompresses the data (1506), and then writes the decompressed data to the stream interface using the response object (1508). Because the decompressor object has been initialized to accept a number of bytes from the stream interface that corresponds to the compressed length of the component, it will only read the bytes that form the compressed component. If the entire compressed component has not been read (1510), the repository object reads more data from the physical repository (1502). Once the decompressor object has decompressed and written the entire component into the stream interface (1510), the repository object returns control of the system back to the component object (1512).

For components that do not require decompression, the process of writing the component into the stream interface mirrors the process described in FIG. 15. The primary difference is that the non-compressor object will not decompress the data that is read out of the physical repository. Otherwise, the process is executed in an almost identical way.

In FIG. 16, the component object executes a process 1600 when the repository object returns system control to the component object. Here, the component object simply terminates the compressor object (1602) and returns system control to the document object (1604).

In FIG. 17, the document object executes a process 1700 when the component object returns system control to the document object. The document object terminates the component object (1702) and determines if another component needs to be read out of the repository and written to the client over the stream interface (1704). If there is another component to be retrieved, the document object writes a new boundary string to separate the next component (1314 of FIG. 13), generates a new component object (1316 of FIG. 13), and the process of retrieving a component is executed again (1706). If there are no more components to be retrieved, the document object writes an end boundary string into the stream interface and then commits the transaction (1708), and returns system control to the query object (1710).

In FIG. 18, the query object executes a process 1800 when the document object returns system control to the query object. The query object simply terminates the document object (1802) and returns system control to the server state object (1804). FIG. 19 is a process 1900 executed by the server state object when it receives system control from the query object. The server state object terminates any remaining run time objects generated during the retrieval process, including the request object, the response object, the repository object, and the query object (1902). Finally, the process of retrieving the document is complete and the server state object returns control of the system back to the web server (1904).

In an implementation of the invention, additional objects can be generated in the content server 100 to perform additional functions. For instance, a virus scanning object can be generated downstream of the decompressor object to perform a virus check on a document that is being retrieved from the repository 104 before the document is written into the stream interface 109. In another example, a format converting object can be generated downstream of the decompressor object to change the format of the document before it is written into the stream interface 109. So a document that is stored as a Microsoft Word(t document, for instance, can be converted into a PDF file if that is the format requested by the user. A searching component can also be generated to read documents out of the repository 104 to find a specific character string requested by a user.

If the document contains a single component, another process that can be executed by the content server 100 is the retrieval of a specific portion of a component, rather than retrieving an entire component. A client 102 can provide an offset that corresponds to the location within the component that the requested information begins, and the client 102 can also provide a length that the repository object 116 can read when a read head of the storage device is positioned at the specified offset. If the component is compressed, the component can first be passed through a decompressor object to decompress the component, and another object can then find the offset location within the component and read the requested length of data.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. Accordingly, other embodiments are within the scope of the following claims.

What is claimed is:

1. A method for storing a document in a document repository comprising:
receiving a client request to store a document;
generating a query object;
validating the client request with the query object;
generating a document object;
initiating a transaction in the document repository with the document object using data in the client request;
generating a data retrieval object;
reading data from a client with the data retrieval object, wherein the data comprises a component of the document; and
storing the component in the document repository.

2. The method of claim 1, wherein the client request comprises a document header.

3. The method of claim 2, wherein the document header is pre-parsed by a web server.

4. The method of claim 1, wherein the client request comprises a URL accessed by the client and a socket identifier for establishing a communication path to the client.

5. The method of claim 1, wherein the validating of the client request with the query object comprises parsing the client request with the query object to verify that the client has authorization to request storing of the document and to verify that any data required for storing the document is present.

6. The method of claim 1, wherein the data in the client request comprises a name of the document being stored.

7. The method of claim 1, further comprising:
generating a server state object; and
receiving the client request to store the document with the server state object.

8. The method of claim 1, further comprising:
generating a component object;
determining if the component needs to be compressed with the component object using data in the client request; and
if the component needs to be compressed:
generating a compressor object,
implementing the compressor object as the data retrieval object, and
compressing the data read from the client prior to storing the component in the document repository.

9. The method of claim 1, further comprising:
generating a repository object; and
using the repository object to store the component in the document repository.

10. The method of claim 1, further comprising:
generating a virus scan object; and
scanning the component prior to storing the component in the document repository.

11. The method of claim 1, further comprising:
generating a searching object; and
searching the component prior to storing the component in the document repository.

12. A method for storing a multi-component document in a document repository comprising:
receiving a client request to store a document that includes at least two components;
generating a query object;
validating the client request with the query object;
generating a document object;
initiating a transaction in the document repository with the document object using data in the client request;
reading at least one boundary string from a client with the document object, wherein the boundary string is used to separate the components;
generating a data retrieval object;
reading data from the client with the data retrieval object, wherein the data comprises the at least two components; and
storing the components in the document repository.

13. The method of claim 12, wherein the client request comprises a document header.

14. The method of claim 13, wherein the document header is pre-parsed by a web server.

15. The method of claim 12, wherein the client request comprises a URL accessed by the client and a socket identifier for establishing a communication path to the client.

16. The method of claim 12, wherein the validating of the client request with the query object comprises parsing the client request with the query object to verify that the client has authorization to request storing of the document and to verify that any data required for storing the document is present.

17. The method of claim 12, wherein the data in the client request comprises a name of the document being stored.

18. The method of claim 12, further comprising:
generating a server state object; and
receiving the client request to store the document with the server state object.

19. The method of claim 12, further comprising:
generating a component object for each component included in the document;
for each component:
reading a component header for the component from the client with the component object, and
determining if the component needs to be compressed with the component object using data in the component header; and
for each component that needs to be compressed:
generating a compressor object,
implementing the compressor object as the data retrieval object, and
compressing the component prior to storing the component in the document repository.

20. The method of claim 12, further comprising:
generating a repository object; and
using the repository object to store each component in the document repository.

21. The method of claim 12, further comprising:
generating a virus scan object; and
scanning each component prior to storing the component in the document repository.

22. The method of claim 1, further comprising:
generating a searching object; and
searching each component prior to storing the component in the document repository.

23. A method for retrieving a document from a document repository comprising:
receiving a client request to retrieve a document;
generating a query object;
validating the client request with the query object;
generating a document object;
initiating a transaction in the document repository with the document object using data in the client request;
generating a data retrieval object;
reading data from the document repository with the data retrieval object, wherein the data comprises a component of the document; and
sending the component to the client.

24. The method of claim 23, wherein the client request comprises a document header.

25. The method of claim 24, wherein the document header is pre-parsed by a web server.

26. The method of claim 23, wherein the client request comprises a URL accessed by the client and a socket identifier for establishing a communication path between to the client.

27. The method of claim 23, wherein the validating of the client request with the query object comprises parsing the client request with the query object to verify that the client has authorization to request retrieval of the document and to verify that any data required for retrieving the document is present.

28. The method of claim 23, wherein the data in the client request comprises a name of the document being retrieved.

29. The method of claim 23, further comprising:
generating a server state object; and
receiving the client request to retrieve the document with the server state object.

30. The method of claim 23, further comprising:
generating a component object;
determining if the component needs to be decompressed with the component object using data in the document repository; and
if the component needs to be decompressed:
generating a decompressor object,
implementing the decompressor object as the data retrieval object, and
decompressing the data read from the document repository prior to sending the component to the client.

31. The method of claim 23, further comprising:
generating a repository object; and
using the repository object to read the component from the document repository.

32. A method for retrieving a multi-component document from a document repository comprising:
receiving a client request to retrieve a document that includes at least two components;
generating a query object;
validating the client request with the query object;
generating a document object;
initiating a transaction in the document repository with the document object using data in the client request;
sending at least one boundary string to a client with the document object, wherein the boundary string is used to separate the components;
generating a data retrieval object;
reading data from the document repository with the data retrieval object, wherein the data comprises the at least two components; and
sending the components to the client.

33. The method of claim 32, wherein the client request comprises a document header.

34. The method of claim 33, wherein the document header is pre-parsed by a web server.

35. The method of claim 32, wherein the client request comprises a URL accessed by the client and a socket identifier for establishing a communication path to the client.

36. The method of claim 32, wherein the validating of the client request with the query object comprises parsing the client request with the query object to verify that the client has authorization to request retrieval of the document and to verify that any data required for retrieving the document is present.

37. The method of claim 32, wherein the data in the client request comprises a name of the document being retrieved.

38. The method of claim 32, further comprising:
generating a server state object; and
receiving the client request to retrieve the document with the server state object.

39. The method of claim 32, further comprising:
generating a component object for each component included in the document;
for each component:
sending a component header for the component to the client with the component object, and
determining if the component needs to be decompressed with the component object using data in the document repository; and
for each component that needs to be decompressed:
generating a decompressor object,
implementing the decompressor object as the data retrieval object, and
decompressing the component prior to sending the component to the client.

40. The method of claim 32, further comprising:
generating a repository object; and
using the repository object to retrieve each component from the document repository.

41. A computer program product, tangibly embodied in an information carrier, for storing a document in a document repository, the computer program product being operable to cause data processing apparatus to:
receive a client request to store a document;
generate a query object;
validate the client request with the query object;
generate a document object;
initiate a transaction in the document repository with the document object using data in the client request;
generate a data retrieval object;
read data from a client with the data retrieval object, wherein the data comprises a component of the document; and
store the component in the document repository.

42. A computer program product, tangibly embodied in an information carrier, for storing a multi-component document in a document repository, the computer program product being operable to cause data processing apparatus to:
receive a client request to store a document that includes at least two components;
generate a query object;
validate the client request with the query object;
generate a document object;
initiate a transaction in the document repository with the document object using data in the client request;
read at least one boundary string from a client with the document object, wherein the boundary string is used to separate the components;
generate a data retrieval object;
read data from the client with the data retrieval object, wherein the data comprises the at least two components; and
store the components in the document repository.

43. A computer program product, tangibly embodied in an information carrier, for retrieving a document from a document repository, the computer program product being operable to cause data processing apparatus to:
receive a client request to retrieve a document;
generate a query object;
validate the client request with the query object;
generate a document object;
initiate a transaction in the document repository with the document object using data in the client request;
generate a data retrieval object;
read data from the document repository with the data retrieval object, wherein the data comprises a component of the document; and
send the component to the client.

44. A computer program product, tangibly embodied in an information carrier, for retrieving a multi-component document from a document repository, the computer program product being operable to cause data processing apparatus to:
receive a client request to retrieve a document that includes at least two components;
generate a query object;
validate the client request with the query object;
generate a document object;
initiate a transaction in the document repository with the document object using data in the client request;
send at least one boundary string to a client with the document object, wherein the boundary string is used to separate the components;
generate a data retrieval object;
read data from the document repository with the data retrieval object, wherein the data comprises the at least two components; and
send the components to the client.

45. A computer program product, tangibly embodied in an information carrier, for storing a document, the computer program product being operable to cause data processing apparatus to:
in a client server network, generate a query object and a document object for a client request to store a document;
initiate a transaction in a document repository;
read data comprising a component of the document from a client with a generated data retrieval object; and
store the component in the document repository.

46. A computer program product, tangibly embodied in an information carrier, for storing a document, the computer program product being operable to cause data processing apparatus to:
in a network, receive a client request to store a document that includes at least two components;
generate a query object and a document object;
initiate a transaction in a document repository with the document object using data in the client request;
read at least one boundary string from a client with the document object;
generate a data retrieval object;
read data comprising the at least two components from the client with a generated data retrieval object; and
store the components in the document repository.

47. A method of storing a document in a document repository comprising:
using a first set of objects to process information about the document without receiving the document itself; and
using a second set of objects to receive and store the document.
